(19) United States
(12) Patent Application Publication
(10) Pub. No.: US 2006/0165925 A1
(43) Pub. Date: Jul. 27, 2006

(54) Mussel sock with zipper strip

(75) Inventor: James A. Shelby, Aurora, IL (US)

Correspondence Address: BANNER & WITCOFF, LTD., TEN SOUTH WACKER DRIVE, SUITE 3000, CHICAGO, IL, 60606, US

(73) Assignee: Delaware Capital Formation, Inc., Wilmington, DE (US)

(21) Appl. No.: 11/176,733

(22) Filed: Jul. 7, 2005

Related U.S. Application Data
(60) Provisional application No. 60/646,176, filed on Jan. 21, 2005.

(51) Int. Cl. D03D 9/00; B31B 45/00

(52) U.S. Cl. 428/34.1; 442/49; 428/36.3

(57) ABSTRACT

A netting material is comprised of both degradable and non-degradable sections. The degradable portions or sections fail over time to enable access to the internal contents of a package made by the non-degradable netting material.

### BACKGROUND OF THE INVENTION

In a principal aspect the present invention relates to a netting material comprised of generally non-degradable sections and degradable sections which enables placement of the netting in an environment where degradation of the degradable section facilitates use of the netting process. By way of example and not limitation, the netting material may be used in the growth or farming of mollusks such as mussels.

Woven plastic netting material is utilized for various purposes. For example, the netting may be woven into a tubular configuration and filled with various materials for use in erosion control, oil spillage contamination control on the surface of a pond and the like and also as an incubation environment for various types of mollusk growth. That is, a tube of plastic netting may serve as a place in which seeds for mollusks are placed. The mollusks can then be placed in a nutrient environment. After a period of time in the environment, the tube may be removed from that environment and cut open to provide access to the grown mollusks that have grown in the netting. The netting may also be used as a packaging material. For example, it may be formed in an appropriate size for packaging and shipping Christmas trees, food products and the like.

A problem which has been observed with respect to the use of such netting, particularly when it is in a tubular form, has been the removal of netting from the packaged material or item. Often the net packaging material is so strong that removal or access to the contents of the package becomes somewhat difficult requiring special net removal tools, for example. The same can be said with respect to attempting to harvest products such as mollusks when the plastic netting material is used for such a purpose.

Thus, there has developed a need to provide a netting material which maintains its variety of uses, yet which when desired, may be more easily opened from a tubular form. These among other objectives have led to the development of the present invention.

### SUMMARY OF THE INVENTION

Briefly, the present invention comprises a netting material which is comprised of at least two disparate or different materials. The first material which forms the majority of the netting is a generally non-degradable material such as a plastic netting material. The second material is a generally degradable material which degrades over a desired time frame such as a cotton fabric or cord. The second material is used to join sections of the first material and facilitates formation of an enclosure by the combined materials. The second or degradable material may thus join opposed sections or opposed edges of the generally non-degradable material to thereby form an enclosure into which products or other items may be placed. The degradable material will then be placed along with the non-degradable material in an environment which, over time, may effect degradation to enable the enclosure formed by the netting material to be opened or accessed depending upon the particular arrangement of the degradable and non-degradable materials.

The material is especially useful in the farming or growth of mollusks or shell fish. By way of example and not limitation, mollusks may be placed in a tubular netting comprised of the degradable and non-degradable materials. That seeded netting may then be placed in a nutrient. Over time, the degradable portion of the netting will break down thereby either enlarging the enclosure or opening the enclosure as the mollusks, such as mussels, within the nutrient environment grow. This facilitates growth of the product within the netting and further enhances the ability to achieve access to the final product.

Thus, it is an object of the invention to provide an improved netting material.

It is a further object of the invention to provide a netting material which will selectively degrade, at least in part, to facilitate its utility.

Another object of the invention is to provide a netting material which is easy to use, inexpensive, and which requires a minimum amount of preparation to effect its use.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is a flow diagram depicting the use of the netting material of the invention in one of various potential selected uses and environments;

FIG. 2 is a diagrammatic view of the netting material which may be used in the process represented by FIG. 1;

FIG. 3 is a diagrammatic view of a subsequent step to FIG. 2 in use of the invention;

FIG. 4 is a diagrammatic view of a further step subsequent to that set forth in FIG. 3;

FIG. 5 is a diagrammatic view illustrating an alternative embodiment of the invention; and

FIG. 6 is a further diagrammatic view representing a subsequent step in use for the embodiment of FIG. 5.

### DESCRIPTION OF THE PREFERRED EMBODIMENT

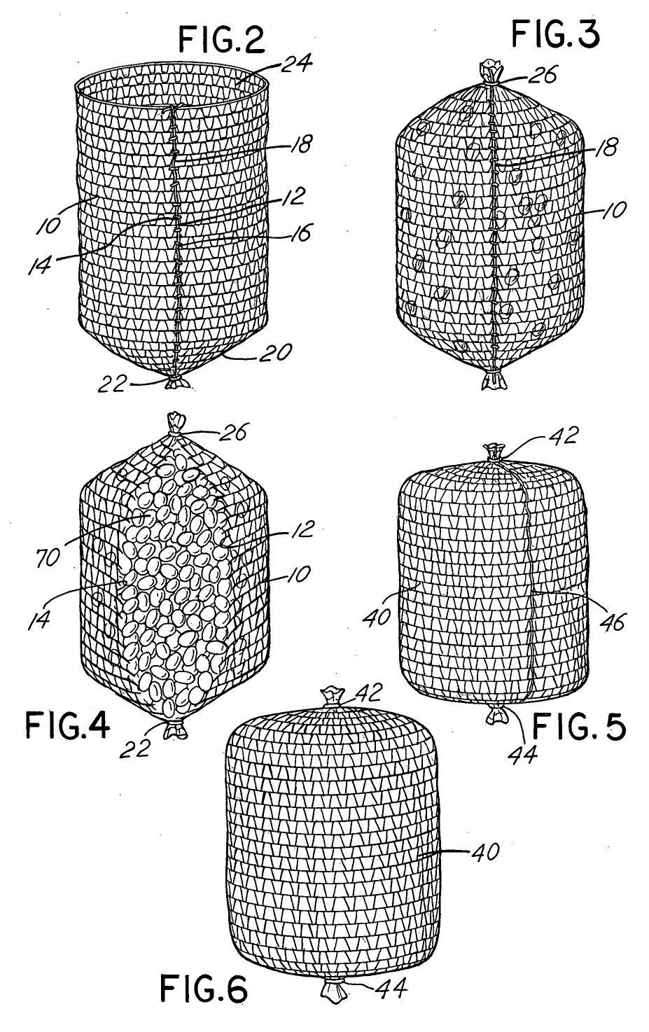

Referring to the figures, and in particular initially referring to FIGS. 2-4, there is illustrated an example of the invention and of the utility that may be addressed by the invention. In FIG. 2, a substantially non-degradable plastic netting material 10 is formed in the shape of a tube and includes opposed edges 12 and 14 joined together along a seam 16 by a generally degradable cord 18. For example, the netting 10 may be formed of a polypropylene or other plastic material. The cord 18 may be formed from cotton or a biodegradable polymeric or some other fiber. The tubular configuration of the enclosure 10 is, in one embodiment, closed at one end 20 by a metal clip or staple 22, for example. Product or items may then be placed into the open end 24 of the tubular configuration. Subsequently, as illustrated in FIG. 3, the open end 24 may be closed, for example, by a metal clip 23, 26.

The tubular enclosure 10 may then be placed in an environment which will cause the cord 18 to degrade over time. For example, it may be placed in a salt water solution or some other solution that will effect biodegradation. FIG. 4 represents the resultant outcome of placement in such an environment. There, the cord 18 has degraded causing opening the tube 10 so that the opposed sides or edges 12 and 14 open or spread apart to expose the contents of the tube 10. Note that the clips 22 and 26 remain affixed or attached to the non-degraded material.

As an alternative to the embodiment depicted by FIGS. 2, 3 and 4, reference is directed to FIGS. 5 and 6. In this embodiment, a non-degradable netting material 40 is formed in the shape of a tube with a clip 42 attached to one end and a separate clip 44 attached to its opposite end. The tube is formed as a total enclosure from a non-degradable netting material. A section or wing of the tube 40 is, however, joined by a degradable material, for example, a cotton cord 46 which, in effect, reduces the size of the tube. Thus, the tube which is filled prior to attachment of the clip 42 will have a restricted size.

Then, as represented by FIG. 6, over time when the tube of FIG. 5 is placed into some type of degradation environment, the cord 46 will dissolve or fracture, or otherwise become ineffective. This enables the tube 40 to assume its full size with respect to the contents thereof.

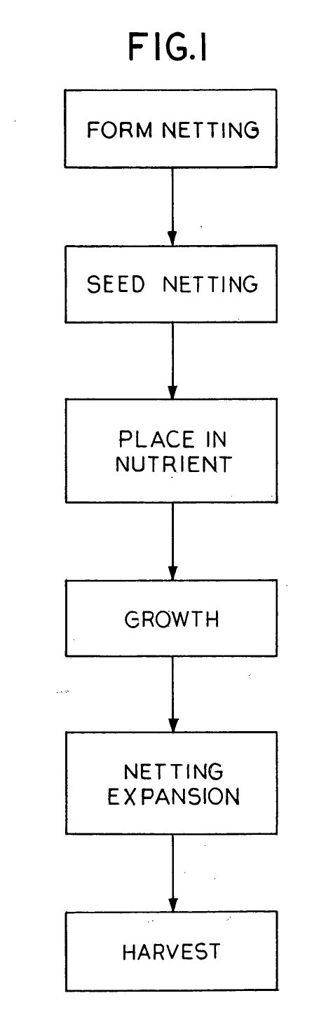

FIG. 1 illustrates a series of steps which demonstrate the utility of the invention. Thus, the netting is formed as a first step in a manner depicted in FIG. 2 or FIG. 5. The netting which has been formed is filled with seeds, for example, seeds for the growth of mussels. Note that the mesh or size of the netting becomes important inasmuch as the seeds must not fall through the mesh.

Subsequently, the seeded netting is sealed in a manner depicted in FIG. 3 and placed in a nutrient environment, for example, sea water in the event mussels are to be grown. The nutrient in the water enables growth of the seeds into full sized mussels over a period of time upwards of at least three months, but typically more than 3-6 weeks. As the growth occurs and the mussels grow, it will be necessary for the netting to expand. The netting may include, for example, a section such as defined by the cord 46 in FIG. 5 to permit expansion. The netting may also include a seam such as the seam represented by the cord 18 in FIG. 2. One or both of these uses of the degradable cording material may be utilized. Finally, the resultant product is harvested inasmuch as, in a preferred embodiment, the cord 18 will open to expose the product, such as the mussels 70 in FIG. 4.

There are many alternative aspects of the invention. In the description given, the cord 18 is degradable over a period of time. However, the cord 18 may have a lesser tensile strength, thus enabling ease of access to packaged material when it is desired to remove the items within the package. The cord 18 thus acts to function as a “zipper” for access to the package. The degradable material may also be provided in various patterns, such as the pattern of FIG. 5, or various other patterns to facilitate growth, access or change within the packaging material. Thus, there is a wide variety of degradable materials as well as generally non-degradable materials. Therefore, the invention should be limited only by the following claims and equivalents thereof.

What is claimed is:

1. A netting construction comprising, in combination:
a substantially non-degradable netting having opposed sections; and
a generally degradable linkage material joining the opposed sections to form an enclosure, said linkage degradable over time to enable opening and enlargement of the enclosure.

2. The netting construction of claim 1 wherein the linkage comprises a biodegradable material.

3. The construction of claim 1 wherein the non-degradable netting is a plastic netting material.

4. The construction of claim 1 wherein the enclosure is generally tubular.

5. The construction of claim 1 wherein the enclosure comprises an elongate tubular configuration.

6. The construction of claim 1 wherein the linkage comprises a cord threaded to the opposed sections.

7. The construction of claim 1 wherein the linkage comprises a cord selected from a biodegradable group consisting of cotton, polymerics, natural fibers and combinations thereof.

8. The construction of claim 1 wherein the linkage degrades over a time period exceeding at least about twenty eight days.

9. The construction of claim 1 wherein the non-degradable netting is comprised of a woven fabric of plastic fiber.

10. A method for farming mollusks comprising the steps of:
(a) inserting seeds in an enclosure comprised of a generally substantially non-biodegradable netting body having opposed sections joined by a generally biodegradable linkage, said netting having a mesh size dimensioned to retain the seeds within the enclosure;
(b) placing the seeded enclosure in a seed growth environment to facilitate growth thereof;
(c) maintaining the seeded enclosure within the growth environment for a period of time adequate to result in growth of the seeds and to enable degradation of the linkage to accommodate growth and expansion of the seeds by alteration of the enclosure capacity; and
(d) harvesting the resultant mollusk.

11. The method of claim 10 wherein the mollusks are mussels.

12. The method of claim 10 wherein the enclosures comprise generally elongate tubes.

13. The method of claim 10 wherein the enclosures include more than one linkage.

14. The method of claim 10 wherein the enclosure comprises an additional linkage joining sections of the netting forming the enclosure to restrict the size of the enclosure.

15. The method of claim 10 wherein the netting comprises an enclosure entirely of generally non-degradable material and the opposed sections comprise portions of the netting joined by a linkage of degradable material.

16. The construction of claim 1 wherein the non-degradable netting is in the form of a tube and the linkage comprises a material selected from the group consisting of cotton, polymerics, fibers and combinations thereof.
